(19) United States
(12) Patent Application Publication
(10) Pub. No.: US 2011/0040535 A1
(43) Pub. Date: Feb. 17, 2011

(54) GOLF BALL TRAJECTORY SIMULATION METHOD

(75) Inventor: Katsunori Sato, Chichibu-shi (JP)

Correspondence Address: SUGHRUE MION, PLLC, 2100 PENNSYLVANIA AVENUE, N.W., SUITE 800, WASHINGTON, DC, 20037, US

(73) Assignee: BRIDGESTONE SPORTS CO., LTD., Tokyo (JP)

(21) Appl. No.: 12/763,425

(22) Filed: Apr. 20, 2010

(51) Int. Cl. G06F 17/50; G06F 17/10

(52) U.S. Cl. 703/2; 703/6; 703/9

(57) ABSTRACT

The invention is directed at a golf ball trajectory simulation method that employs arithmetic operations executed by a computer to analyze a trajectory of a golf ball having a plurality of dimples on a surface thereof when the ball is launched into flight. The trajectory of the ball is estimated by setting up a golf ball model within a virtual airflow space (field) where a grid has been generated; setting a weight for the golf ball model and applying initial conditions (initial velocity, launch angle, spin rate) to the ball model so as to cause the model to fly within the virtual airflow space (field); calculating a lift coefficient and a drag coefficient for the golf ball from an air stream velocity, direction and pressure calculated in each grid cell; and calculating a flight distance and left-to-right dispersion for the golf ball from launch until landing by calculating a change in height, a change in lateral direction, a change in velocity and a change in spin rate for the golf ball during flight.

### BACKGROUND OF THE INVENTION

The present invention relates to a golf ball trajectory simulation method which estimates the trajectory of a golf ball having a plurality of dimples on a surface thereof by setting up a golf ball model on a computer and employing arithmetic operations by the computer to calculate elements of motion for the golf ball model.

It is known that when a physical body such as golf ball flies through the atmosphere, air flow turbulence arises around the body. If the surface of the body has a complex shape or the body spins while flying, the air flow turbulence during flight is complex and exerts a major influence on the flight performance of the body, such as the flight distance.

Golf balls are most often provided with a large number of dimples of circular shape, as seen in a plan view. Because the combination of dimple parameters such as three-dimensional shape, arrangement and size has a major influence on the aerodynamic properties of the golf ball, it is necessary to understand the causal relationship between these dimple parameters and the aerodynamic properties.

Usually, to investigate the influence of changes in dimple parameters such as shape, construction and arrangement on the flight performance of golf balls, a variety of molds for molding golf balls are fabricated and various golf balls are test-produced. The balls are then subjected to ball striking tests and properties such as the initial velocity, spin rate and trajectory (flight distance, height) are measured, from which the aerodynamic properties are evaluated.

However, such experimental evaluation based on actual physical prototypes is time-consuming and costly, and moreover cannot clearly establish the causal relationships between the dimple shapes and arrangement and the aerodynamic properties of the ball. For this reason, a golf ball that has been newly designed based on evaluation results obtained by experimentation often fails to exhibit the intended performance. In such cases, it is necessary each time to again design and produce a ball prototype and verify the aerodynamic properties. Because such a process entails the further expenditure of time and cost, golf balls cannot be efficiently developed in this way.

Prior-art literature relevant to the present invention is shown below.

### (1) JP-A 2002-358473

### (2) JP-A 2006-275722

### (3) JP-A 2005-034378

### (4) JP-A 2002-340735

### (5) JP-A 2002-250739

### SUMMARY OF THE INVENTION

It is therefore an object of the present invention to provide a method for efficiently developing golf balls by evaluating the trajectory of a golf ball having a plurality of dimples on a surface thereof without relying on experimental evaluation using an actual physical prototype.

Accordingly, the invention provides the following golf balls.

[1] A golf ball trajectory simulation method that employs arithmetic operations executed by a computer to analyze and estimate a trajectory of a golf ball having a plurality of dimples on a surface thereof when the ball is launched into flight, comprising the steps of:

(A) generating a grid within a virtual airflow space (field) where the ball is to be launched;

(B) setting up within the virtual airflow space (field) a substantially spherical golf ball model having a plurality of dimples formed on a surface thereof;

(C) dividing the grid into cells in such a way as to make the grid near the golf ball model finer than the grid within the virtual space (field) and to have the grid gradually increase in size in a direction leading away from the surface of the ball model;

(D) setting a weight for the golf ball model;

(E) applying initial conditions (initial velocity, launch angle, spin rate) to the golf ball model;

(F) initiating movement of the golf ball model under the initial conditions, regenerating in a region of movement the grid near the ball in such a way as to follow the movement of the ball model without disturbing the originally set grid size, and restoring the grid after the ball has passed therethrough to the grid within the virtual airflow space (field);

(G) calculating a lift coefficient and a drag coefficient for the golf ball in flight within the virtual airflow space (field) by integrating an air stream velocity, direction and pressure calculated in each grid cell within the virtual airflow space (field); and

(H) calculating a flight distance and a left-to-right dispersion for the golf ball from launch until landing by calculating a change in height, a change in lateral direction, a change in velocity and a change in spin rate for the golf ball during flight.

[2] The golf ball trajectory simulation method of [1], wherein the grid is shaped as an adaptive Cartesian mesh.
[3] The golf ball trajectory simulation method of [1], wherein the grid is shaped as an unstructured mesh.
[4] The golf ball trajectory simulation method of [1] which calculates the distance traveled by the golf ball after landing until the ball comes to rest, and calculates the distance traveled by the golf ball from launch until coming to rest, from a velocity, angle and spin rate calculated for the golf ball on landing.
[5] A golf ball trajectory simulation method that employs arithmetic operations executed by a computer to analyze and estimate a trajectory of a golf ball having a plurality of dimples on a surface thereof when the ball is launched into flight, comprising the steps of:

(A) generating a grid within a virtual airflow space (field) where the ball is to be launched;

(B) setting up within the virtual airflow space (field) a substantially spherical golf ball model having a plurality of dimples formed on a surface thereof;

(C) dividing the grid into cells in such a way as to make the grid near the golf ball model finer than the grid within the virtual space (field) and to have the grid gradually increase in size in a direction leading away from the surface of the ball model;

(D) setting a weight for the golf ball model;

(D-2) setting up within the virtual airflow space a state wherein an air stream of a given velocity flows into the golf ball model;

(E) applying initial conditions (initial velocity, launch angle, spin rate) to the golf ball model;

(F) initiating movement of the golf ball model under the initial conditions, regenerating in a region of movement the grid near the ball in such a way as to follow the movement of the ball model without disturbing the originally set grid size, and restoring the grid after the ball has passed therethrough to the grid within the virtual airflow space (field);

(G) calculating a lift coefficient and a drag coefficient for the golf ball in flight within the virtual airflow space (field) by integrating an air stream velocity, direction and pressure calculated in each grid cell within the virtual airflow space (field); and

(H) calculating a flight distance and a left-to-right dispersion for the golf ball from launch until landing by calculating a change in height, a change in lateral direction, a change in velocity and a change in spin rate for the golf ball during flight.

[6] The golf ball trajectory simulation method of [5], wherein the grid is shaped as an adaptive Cartesian mesh.
[7] The golf ball trajectory simulation method of [5], wherein the grid is shaped as an unstructured mesh.
[8] The golf ball trajectory simulation method of [5] which calculates the distance traveled by the golf ball after landing until the ball comes to rest, and calculates the distance traveled by the golf ball from launch until coming to rest, from a velocity, angle and spin rate calculated for the golf ball on landing.

This trajectory simulation method enables the trajectory of a golf ball having a plurality of dimples on the surface thereof, when launched at any initial velocity, any spin rate and any angle, to be estimated without carrying out experimental evaluation using an actual physical prototype, and also enables the trajectory under the effect of wind conditions, such as a tailwind, headwind or crosswind, to be estimated.

As a result, the time taken to evaluate the surface shape of a golf ball (e.g., shape, arrangement and size of the dimples) is shortened and the accuracy and objectivity of evaluation are enhanced, enabling product of a higher performance to be efficiently developed for the type and grade of golf ball.

### BRIEF DESCRIPTION OF THE DIAGRAMS

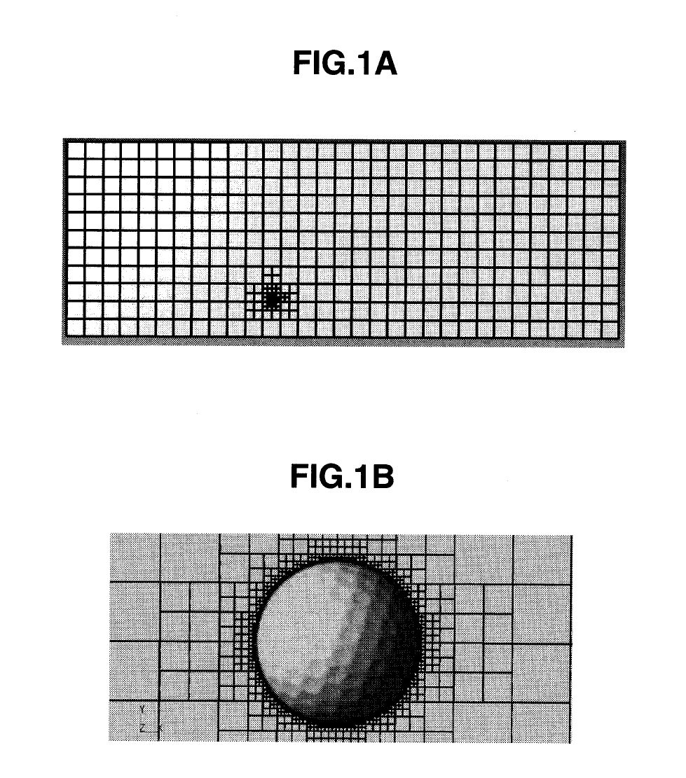

FIG. 1 depicts a golf ball model and a virtual airflow space in the method of the present invention, (A) being a schematic view of a virtual airflow space in its entirety, and (B) being an enlarged schematic view showing the vicinity of a golf ball model in (A).

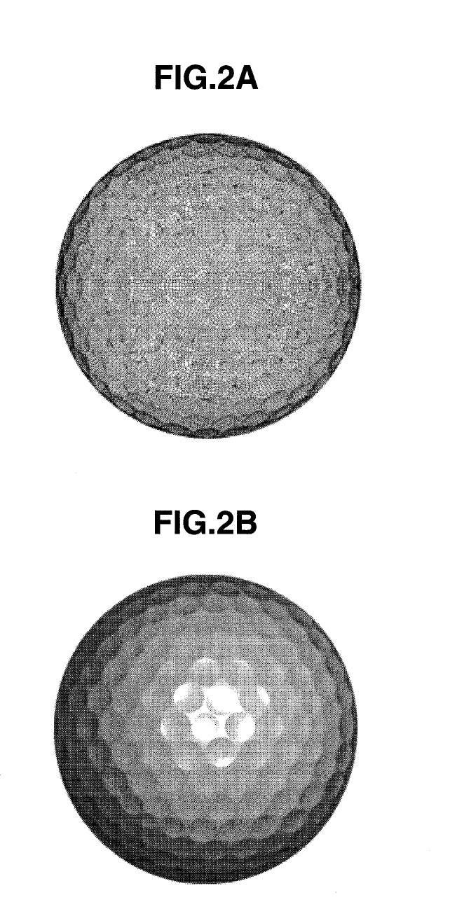

FIG. 2 shows an example of a golf ball model in the present invention, (A) being a view showing face cells formed on the surface, and (B) being a view showing dimples formed on the surface.

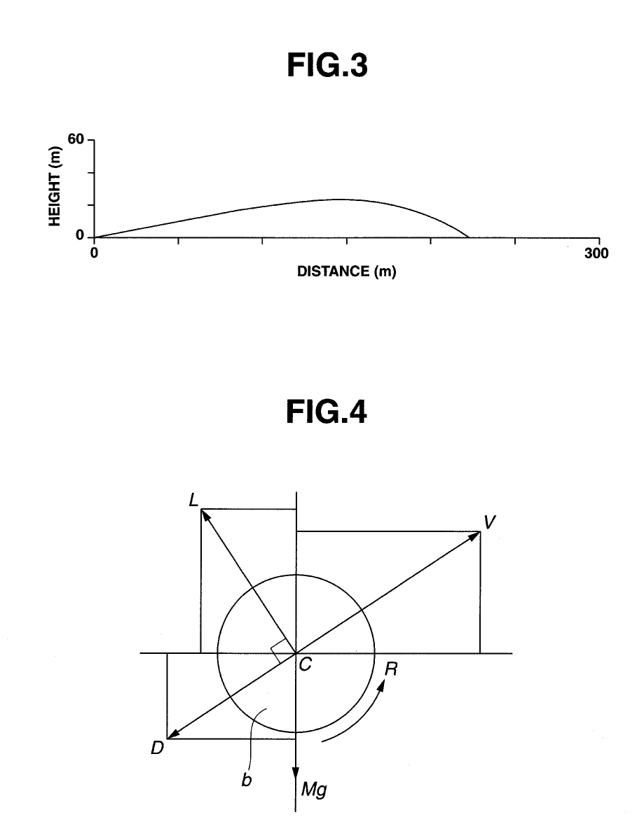

FIG. 3 is a diagram showing an example of a golf ball trajectory estimated by the trajectory simulation method of the present invention.

FIG. 4 is a diagram showing the forces that act on a golf ball that spins while in flight.

### DETAILED DESCRIPTION OF THE INVENTION

The invention is described more fully below in conjunction with the diagrams.

The golf ball trajectory simulation method of the invention employs arithmetic operations executed by a computer to analyze the trajectory of a golf ball having a plurality of dimples on the surface thereof when the ball is launched into flight.

In the golf ball trajectory simulation method of the invention, first, (A) a virtual airflow space (field) where the ball is to be launched is set up by computer and, as shown in FIG. 1A, a grid is generated within the virtual airflow space (field). Although not subject to any particular limitation, the grid formed within the virtual airflow space (field) may be shaped as an adaptive Cartesian mesh or an unstructured mesh.

The virtual airflow space (field) represents the entire region from where the golf ball is launched and travels in flight and at least up until where the ball lands, with the subsequently described golf ball model moving within this virtual airflow space (field).

Next, as shown in FIG. 1, (B) a substantially spherical golf ball model having a plurality of dimples formed on a surface thereof is set up within the virtual airflow space (field). This golf ball model, which may be created by 3D CAD, is exemplified by the golf ball model shown in FIG. 2.

When the golf ball model is set up within the virtual airflow space (field), (C) the grid is divided into cells in such a way as to make the grid near the golf ball model finer than the grid within the virtual space (field) and to have the grid gradually increase in size in a direction leading away from the surface of the ball model. By dividing the grid near the golf ball model into cells in this way, excessive calculations can be avoided, enabling computation to be carried out more efficiently.

Specifically, first, as shown in FIG. 2A, the surface of the golf ball model is divided into cells measuring, for example, about 0.002 mm on a side, thereby setting up a large number of polygonal (e.g., triangular, quadrangular) or substantially polygonal (e.g., substantially triangular, substantially quadrangular) face cells, and grid cells adjoining the golf ball model surface which is entirely covered by these individual face cells are set up. The grid cells adjoining the golf ball model surface are set in a substantially polygonal prismatic shape such as a substantially quadrangular prismatic shape, or in a substantially polygonal pyramidal shape. Also, as shown in FIG. 1B, from the grid cells adjoining the golf ball model surface, the remainder of the virtual airflow space (field) is divided grid-like into cells in such a way that the volume of the grid cells gradually increases in directions leading away from the golf ball. In this way, the entire virtual airflow space is divided into grid cells.

The grid cells formed in the remainder of the virtual airflow space (field) other than the grid cells adjoining the golf ball model surface have shapes exemplified by polyhedrons such as hexahedrons, triangular prismatic pentahedrons, quadrangular pyramidal pentahedrons and triangular pyramidal tetrahedrons. Grid cells having these shapes may be set up in suitable combinations.

Because the air streams around a golf ball have a larger influence when close to the golf ball, as shown in FIG. 1B and explained above, the grid cells are set up in such a way as to be finer near the golf ball model and to be coarser away from the golf ball model where the influence exerted by airstreams is small. The increase in the volume of the grid cells in directions leading away from the ball surface of the golf ball model may be continuous or stepwise.

Next, (D) a weight is set for the golf ball model, and (E) initial conditions (initial velocity, launch angle, spin rate) are applied to the golf ball model, causing the model to move in the virtual airflow space (field).

In this manner, (F) movement of the golf ball model having the weight (D) is initiated under the initial conditions (E) within the virtual airflow space (field), the grid near the ball is regenerated in the region of movement in such a way as to follow the movement of the ball model without disturbing the originally set grid size, and the grid after the ball has passed therethrough is restored to the grid within the virtual airflow space (field).

Then, when the golf ball model flies within the virtual airflow space (field) while spinning at a given rate, an analysis of the elements of motion within the virtual airflow space (field) of the air streams generated by forces which arise from the airflow coming into contact with the spinning golf ball model and which act on the surface of the golf ball model is carried out for each grid cell.

The elements of motion that arise when airflow generated by the flight of the golf ball model has come into contact with the golf ball model are the velocity of the air stream in each axial direction in a three-dimensional spatial coordinate system, the direction of the air stream, and the pressure of the air stream against the ball model surface. These elements of motion can be calculated by substituting numerical values into the basic equations used for computation; that is, the equations of continuity (1) to (3) below corresponding to the law of conservation of mass, and the Navier-Stokes equations (4) to (6) below corresponding to the law of conservation of momentum by a physical body.

$$\begin{matrix}\frac{\partial ρ}{\partial t} + \frac{\partial ( ρ u )}{\partial x} + \frac{\partial ( ρ v )}{\partial y} + \frac{\partial ( ρ w )}{\partial z} = 0 & ( 1 ) \\ div V = \frac{\partial ( ρ u )}{\partial x} + \frac{\partial ( ρ v )}{\partial y} + \frac{\partial ( ρ w )}{\partial z} & ( 2 )\end{matrix}$$

where u, v and w are the velocities in the x, y and z directions, respectively.
Using the divergence operator,

$$\begin{matrix}\frac{\partial ρ}{\partial t} + div ( ρ V ) = 0. & ( 3 ) \\ \frac{Du}{Dt} = Fx - \frac{1}{ρ} \frac{\partial p}{\partial x} + \frac{μ}{ρ} ( \frac{{\partial }^{2} u}{\partial {x}^{2}} + \frac{{\partial }^{2} u}{\partial {y}^{2}} + \frac{{\partial }^{2} u}{\partial {z}^{2}} ) + \frac{1}{3} \frac{μ}{ρ} \frac{\partial }{\partial x} ( \frac{\partial u}{\partial x} + \frac{\partial v}{\partial y} + \frac{\partial w}{\partial z} ) & ( 4 ) \\ \frac{Dv}{Dt} = Fy - \frac{1}{ρ} \frac{\partial p}{\partial y} + \frac{μ}{ρ} ( \frac{{\partial }^{2} v}{\partial {x}^{2}} + \frac{{\partial }^{2} v}{\partial {y}^{2}} + \frac{{\partial }^{2} v}{\partial {z}^{2}} ) + \frac{1}{3} \frac{μ}{ρ} \frac{\partial }{\partial y} ( \frac{\partial u}{\partial x} + \frac{\partial v}{\partial y} + \frac{\partial w}{\partial z} ) & ( 5 ) \\ \frac{Dw}{Dt} = Fz - \frac{1}{ρ} \frac{\partial p}{\partial z} + \frac{μ}{ρ} ( \frac{{\partial }^{2} w}{\partial {x}^{2}} + \frac{{\partial }^{2} w}{\partial {y}^{2}} + \frac{{\partial }^{2} w}{\partial {z}^{2}} ) + \frac{1}{3} \frac{μ}{ρ} \frac{\partial }{\partial z} ( \frac{\partial u}{\partial x} + \frac{\partial v}{\partial y} + \frac{\partial w}{\partial z} ) & ( 6 )\end{matrix}$$

where ρ is the air density, p is the air pressure, and μ is the air viscosity.

In the above simulation, the flow of air may be analyzed for each of the grid cells in the virtual airflow space by arithmetic operations. Using the above equations (1) to (6) for the arithmetic operations, equations (1) to (6) can be discretized according to the division of the virtual airflow space into grid cells, and the operations carried out. The method of simulation to be used may be suitably selected from among, for example, finite difference calculus, finite volume methods, boundary element methods and finite element methods while taking parameters such as the simulation conditions into account.

Here, in some cases, by (D-2) setting up within the virtual airflow space a state wherein an air stream of a given velocity flows into the golf ball model, simulation according to the state of the wind may be carried out.

That is, by creating in the virtual airflow space a stream of air from the side, in the direction of travel by the ball or in the opposite direction, simulation which takes into account the state when there is a tailwind, when there is a headwind or when there is a crosswind can also be carried out. Specifically, when taking into account a headwind, for example, a state is established where an air stream of a given velocity flows into the virtual airflow space from the front of the golf ball model, and the golf ball model is made to move in a state where the air stream has been established in each cell of the entire virtual airflow space. When taking into account a wind state other than a headwind, simulation may be carried out by changing the direction of the inflowing air stream.

Next, (G) a lift coefficient and a drag coefficient for the golf ball in flight within the virtual airflow space (field) are calculated by integrating an air stream velocity, direction and pressure calculated in each grid cell within the virtual airflow space (field).

Here, using a scattering model for the air stream, the lift coefficient CL and the drag coefficient CD can be calculated by substituting velocity values that take into account the degree of turbulence.

The ball model is then made to move under the above lift coefficient and drag coefficient, the ball weight set in step (D) and the initial conditions (initial velocity, launch angle, spin rate) in step (E), and the trajectory is estimated by (H) calculating a flight distance and a left-to-right dispersion for the golf ball from launch until landing by calculating a change in height, a change in lateral direction, a change in velocity and a change in spin rate for the golf ball during flight.

It is known that a golf ball hit with a club and launched into flight incurs, as shown in FIG. 4, gravity Mg, air resistance (drag) D, and also lift L due to the Magnus effect because the ball has spin. FIG. 4 also shows the direction of flight V and the ball center c. In the illustrated case, the golf ball b is spinning in the direction of the arrow R.

The forces acting upon the golf ball in this case are represented by the following trajectory equation (7).

F=FL+FD+Mg (7)

where F: forces acting upon golf ball
FL: lift
FD: drag
Mg: gravity

Movement by the golf ball can be computed from the following equations of motion.

F_{cd}=0.5×CD×ρ×A×V² (8)

F_{cl}=0.5×CL×ρ×A×V² (9)

F_{cd}+F_{cl}+mg=m×dV/dt (10)

where
m: ball weight
g: gravitational acceleration
t: time
CL: coefficient of lift
CD: coefficient of drag
ρ: air density
A: cross-sectional surface area of golf ball
V: velocity of golf ball with respect to air

From this, the velocity of the golf ball after it has flown a very short time is calculated. In addition, by applying the result to Newton's equation of motion relating to parabolic motion, the distance traveled by the ball and its change in height after the ball has flown a very short time can be calculated. The Euler method or the Runge-Kutta method may be used to solve the above differential equations, thereby enabling the velocity for a very short time interval to be calculated.

At the same time, although the spin rate (rotational speed) of the flying golf ball gradually diminishes with the passage of time, the spin rate after a very short time has elapsed can be calculated from the following formulas.

ω=ω₀×Eₓₚ{−(SRD₁+SRD₂×V)×t×β} (11)

β=(π×ρ×r⁴)/1 (12)

where
ω₀: initial angular speed of rotation by golf ball
ω: angular speed of rotation by golf ball
V: velocity of golf ball with respect to air
t: time
ρ: air density
r: radius of golf ball
l: inertial moment of golf ball
SRD₁, SRD₂: attenuation coefficients specific to dimples, as determined by experimentation.

As a result, the flight distance and change in height of the ball after flying for a very short time are calculated, these operations serving as a first step. The foregoing operations are then repeatedly carried out using the calculated spin rate and velocity as the above spin rate and velocity after a very short time has elapsed, enabling the trajectory of the ball to be estimated by successively calculating the flight distance and height of the ball with the passage of each individual very short time interval from the time the ball is launched until the time it lands.

From the standpoint of the efficiency and accuracy of simulation, it is preferable to set the very short time intervals to from 0.001 to 0.1 second.

The trajectory simulation of the invention is demonstrated concretely below using, by way of example, the golf ball model shown in FIG. 2. Here, the ball is set to a weight of 45.3 g, a diameter of 42.7 mm and a moment of inertia of 7.8×10⁻⁶ kg·m². The initial conditions at launch are set to an initial velocity of 67 m/s, a launch angle of 10° and an initial spin rate of 2,520 rpm. This golf ball model is set within a virtual airflow space (field) where a grid has been generated as shown in FIG. 1A. In addition, the fine grid shown in FIG. 2A and FIG. 1B is generated near the golf ball model, and the grid is divided into cells in such a way as to have the grid gradually increase in size in directions leading away from the ball model. The ball model is then caused to move within the virtual airflow space (field) under the above initial conditions, and the lift coefficient CL and drag coefficient CD are calculated, following which the velocity of the golf ball after flying for a given length of time t (e.g., 0.01 second) is computed using above formulas (8), (9) and (10). The flight distance and height of the ball after flying for a given length of time t are then computed from these results using Newton's equation of motion relating to parabolic motion. At the same time, the spin rate of the ball after a given length of time t has elapsed is computed using formulas (11) and (12).

Next, the velocity and spin rate of the golf ball after flying for a given length of time t that have been thus computed are used to similarly compute by the above-described method the flight distance, left-to-right dispersion, height and spin rate of the ball after additionally flying for a given length of time t. The above calculations are then similarly repeated up until the position at which the golf ball lands, thereby enabling the golf ball trajectory shown in FIG. 3 to be obtained.

If necessary, the distance until the golf ball comes to rest after landing (run, rolling distance) is computed from the computed velocity, angle and spin rate of the golf ball when it lands, enabling the distance traveled by the ball from where it is launched up to where it comes to rest to be computed.

The run (rolling distance) can be calculated from the following formula (13).

Run (rolling distance)=A×Land×velocity−B×Land Y velocity+C×Land Angle−D×Land Spin (13)

Here,
Land X velocity: Horizontal landing velocity component (m/s)
Land Y velocity: Sin 2θ×vertical landing velocity component (m/s)
Land Angle: Cos θ
Land Spin: Spin rate on landing
A, B, C, D: Specific coefficients obtained by back calculations from actual golf ball tests. By varying these coefficients, differences in the ground conditions (e.g., grass and concrete) can be reflected in the simulation.

1. A golf ball trajectory simulation method that employs arithmetic operations executed by a computer to analyze and estimate a trajectory of a golf ball having a plurality of dimples on a surface thereof when the ball is launched into flight, comprising the steps of:
(A) generating a grid within a virtual airflow space (field) where the ball is to be launched;
(B) setting up within the virtual airflow space (field) a substantially spherical golf ball model having a plurality of dimples formed on a surface thereof;
(C) dividing the grid into cells in such a way as to make the grid near the golf ball model finer than the grid within the virtual space (field) and to have the grid gradually increase in size in a direction leading away from the surface of the ball model;
(D) setting a weight for the golf ball model;
(E) applying initial conditions (initial velocity, launch angle, spin rate) to the golf ball model;
(F) initiating movement of the golf ball model under the initial conditions, regenerating in a region of movement the grid near the ball in such a way as to follow the movement of the ball model without disturbing the originally set grid size, and restoring the grid after the ball has passed therethrough to the grid within the virtual airflow space (field);
(G) calculating a lift coefficient and a drag coefficient for the golf ball in flight within the virtual airflow space (field) by integrating an air stream velocity, direction and pressure calculated in each grid cell within the virtual airflow space (field); and
(H) calculating a flight distance and a left-to-right dispersion for the golf ball from launch until landing by calculating a change in height, a change in lateral direction, a change in velocity and a change in spin rate for the golf ball during flight.

2. The golf ball trajectory simulation method of claim 1, wherein the grid is shaped as an adaptive Cartesian mesh.

3. The golf ball trajectory simulation method of claim 1, wherein the grid is shaped as an unstructured mesh.

4. The golf ball trajectory simulation method of claim 1 which calculates the distance traveled by the golf ball after landing until the ball comes to rest, and calculates the distance traveled by the golf ball from launch until coming to rest, from a velocity, angle and spin rate calculated for the golf ball on landing.

5. A golf ball trajectory simulation method that employs arithmetic operations executed by a computer to analyze and estimate a trajectory of a golf ball having a plurality of dimples on a surface thereof when the ball is launched into flight, comprising the steps of:
(A) generating a grid within a virtual airflow space (field) where the ball is to be launched;
(B) setting up within the virtual airflow space (field) a substantially spherical golf ball model having a plurality of dimples formed on a surface thereof;
(C) dividing the grid into cells in such a way as to make the grid near the golf ball model finer than the grid within the virtual space (field) and to have the grid gradually increase in size in a direction leading away from the surface of the ball model;
(D) setting a weight for the golf ball model;
(D-2) setting up within the virtual airflow space a state wherein an air stream of a given velocity flows into the golf ball model;
(E) applying initial conditions (initial velocity, launch angle, spin rate) to the golf ball model;
(F) initiating movement of the golf ball model under the initial conditions, regenerating in a region of movement the grid near the ball in such a way as to follow the movement of the ball model without disturbing the originally set grid size, and restoring the grid after the ball has passed therethrough to the grid within the virtual airflow space (field);
(G) calculating a lift coefficient and a drag coefficient for the golf ball in flight within the virtual airflow space (field) by integrating an air stream velocity, direction and pressure calculated in each grid cell within the virtual airflow space (field); and
(H) calculating a flight distance and a left-to-right dispersion for the golf ball from launch until landing by calculating a change in height, a change in lateral direction, a change in velocity and a change in spin rate for the golf ball during flight.

6. The golf ball trajectory simulation method of claim 5, wherein the grid is shaped as an adaptive Cartesian mesh.

7. The golf ball trajectory simulation method of claim 5, wherein the grid is shaped as an unstructured mesh.

8. The golf ball trajectory simulation method of claim 5 which calculates the distance traveled by the golf ball after landing until the ball comes to rest, and calculates the distance traveled by the golf ball from launch until coming to rest, from a velocity, angle and spin rate calculated for the golf ball on landing.
